(19) United States
(12) Patent Application Publication
(10) Pub. No.: US 2023/0026097 A1
(43) Pub. Date: Jan. 26, 2023

(54) ELECTROLYTIC SMELTING FURNACE AND ELECTROLYTIC SMELTING METHOD

(71) Applicant: MITSUBISHI HEAVY INDUSTRIES, LTD., Tokyo (JP)

(72) Inventors: Takashi NAKANO, Tokyo (JP); Ikumasa KOSHIRO, Tokyo (JP); Yuki ASAI, Tokyo (JP); Nobuki UDA, Tokyo (JP)

(21) Appl. No.: 17/772,351

(22) PCT Filed: Aug. 5, 2020
(86) PCT No.: PCT/JP2020/029994

§ 371 Date: Apr. 27, 2022

(30) Foreign Application Priority Data
Nov. 7, 2019 (JP) 2019-202753

(51) Int. Cl. C25C 7/02; C25C 1/06; C25C 3/26; C25C 3/34; C25C 7/06; F27B 14/06; F27B 14/10; F27B 14/14; F27B 14/20; F27D 27/00

(52) U.S. Cl. CPC C25C 7/02; C25C 1/06; C25C 3/26; C25C 3/34; C25C 7/06; F27B 14/06; F27B 14/10; F27B 14/14; F27B 14/20; F27D 27/007; F27B 2014/068; F27M 2003/13

(57) ABSTRACT

Metals are smelted properly. An electrolytic smelting furnace includes a furnace body, a furnace bottom electrode provided at a bottom part in the furnace body, and an upper electrode provided above the furnace bottom electrode in the furnace body, and the upper electrode includes a conductive compound with a spinel-type structure.

### FIELD

The present invention relates to an electrolytic smelting furnace and an electrolytic smelting method.

### BACKGROUND

For example, heat treatment in blast furnaces and converter furnaces has been widely used as a technology to refine iron ore. In this method, iron ore as a metal material and coke as a reducing material are burned in the furnace. In the furnace, carbon in the coke deprives the iron of oxygen, producing heat, carbon monoxide, and carbon dioxide. This reaction heat melts the iron ore and produces pig iron. After that, by removing oxygen and impurities from the pig iron, pure iron is obtained.

Here, the above method requires a large amount of carbon, including coke, and thus produces a large amount of carbon monoxide and carbon dioxide. As the measures against air pollution have become stricter in recent years, smelting technologies that produce less of these carbon-containing gases are required. One example of such technologies is an electrolytic smelting method described in Patent Literature 1 below.

In the electrolytic smelting method, voltage is applied while melted iron ore is interposed between a furnace bottom electrode and an upper electrode inside a furnace with a flat furnace bottom. As a result, a melted electrolyte including a slag component precipitates on the upper electrode side, and melted iron (pure iron) precipitates on the furnace bottom electrode side. For example, metal materials including iron, chromium, vanadium, and tantalum are used as the upper electrode.

### CITATION LIST

### Patent Literature

Patent Literature 1: U.S. Pat. No. 8,764,962

However, there is room for improvement in the electrolytic smelting method disclosed in Patent Literature 1 for proper metal smelting.

The present invention has been made to solve the above-mentioned problems, and it is an object of the present invention to provide an electrolytic smelting furnace and an electrolytic smelting method capable of properly smelting metals. Solution to Problem

### SUMMARY

### Technical Problem

In order to solve the above-mentioned problems and achieve the object, an electrolytic smelting furnace according to the present disclosure includes: a furnace body; a furnace bottom electrode provided at a bottom part in the furnace body; and an upper electrode provided above the furnace bottom electrode in the furnace body, the upper electrode including a conductive compound with a spinel-type structure.

In order to solve the above-mentioned problems and achieve the object, an electrolytic smelting furnace according to the present disclosure includes: a furnace body; a furnace bottom electrode provided at a bottom part in the furnace body; an upper electrode provided above the furnace bottom electrode in the furnace body; a power supply unit that applies voltage between the furnace bottom electrode and the upper electrode; and a voltage control unit that controls the voltage applied by the power supply unit, the voltage control unit setting a value of the voltage based on a type of an object to be smelted.

In order to solve the above-mentioned problems and achieve the object, an electrolytic smelting furnace according to the present disclosure includes: a furnace body in which an electrolytic solution is stored; a furnace bottom electrode provided at a bottom part in the furnace body; an upper electrode provided above the furnace bottom electrode in the furnace body; a heating unit that heats and melts a smelted object; and a moving mechanism that moves the upper electrode, wherein when the smelted object is heated by the heating unit, the moving mechanism places the upper electrode at a position where the upper electrode is not immersed in the electrolytic solution.

In order to solve the above-mentioned problems and achieve the object, an electrolytic smelting method according to the present disclosure is for performing electrolytic smelting with the above-mentioned electrolytic smelting furnace.

### Advantageous Effects of Invention

According to the present invention, metals can be smelted properly.

### BRIEF DESCRIPTION OF DRAWINGS

FIG. 1 is a schematic diagram of an electrolytic smelting furnace according to a first embodiment.

FIG. 2 is a schematic block diagram of a control unit in the first embodiment.

FIG. 3 is a graph expressing an example of a reduction potential at each temperature.

FIG. 4 is a graph expressing an example of a current value flowing for each applied voltage when metal is reduced.

FIG. 5 is a schematic diagram of an electrolytic smelting furnace according to a third embodiment.

FIG. 6 is a schematic diagram of an upper electrode in the third embodiment.

FIG. 7 is a schematic cross-sectional diagram of a second electrode in the third embodiment.

FIG. 8 is a schematic diagram expressing a position of the upper electrode at smelting.

FIG. 9 is a schematic diagram for describing heating of an electrolyte solution in the third embodiment.

FIG. 10 is a schematic diagram for describing heating of the electrolyte solution in the third embodiment.

FIG. 11 is a schematic diagram expressing the position of the upper electrode at heating of an object.

FIG. 12 is a schematic diagram for describing heating of the object in the third embodiment.

FIG. 13 is a flowchart for describing a process of smelting and melting the object in the third embodiment.

FIG. 14 is a schematic diagram illustrating another example of a heating unit in the third embodiment.

### DESCRIPTION OF EMBODIMENTS

Preferred Embodiments of the Present Invention are hereinafter described in detail with reference to the accompanying drawings. The present invention is not limited by the embodiments, and when there is more than one embodiment, the embodiments may be combined with each other.

### First Embodiment

### Structure of Electrolytic Smelting Furnace

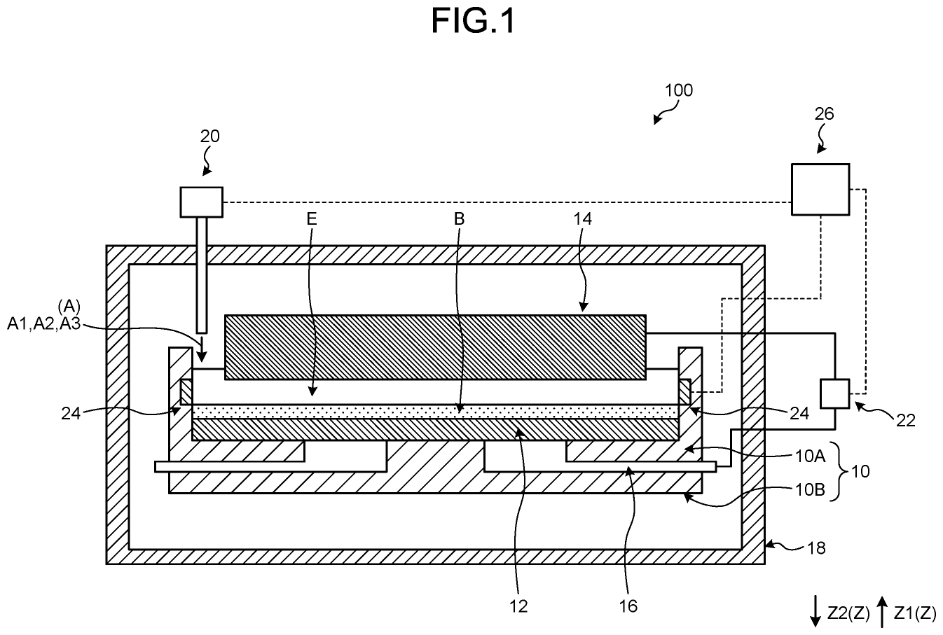

FIG. 1 is a schematic diagram of an electrolytic smelting furnace according to a first embodiment. An electrolytic smelting furnace 100 according to the first embodiment is a device for melting a raw material A and electrolyzing the melted material A so as to smelt (manufacture) an object B. The raw material A and the object B will be discussed below. As illustrated in FIG. 1, the electrolytic smelting furnace 100 includes a furnace body 10, a furnace bottom electrode 12, an upper electrode 14, a collector 16, a housing 18, a loading unit 20, a power supply unit 22, a heating unit 24, and a control unit 26. The vertical direction is hereinafter referred to as a Z direction. Additionally, one of the directions along the Z direction, in this case vertically upward, is defined as a Z1 direction. The other direction along the Z direction, in this case vertically downward, is defined as a Z2 direction.

The furnace body 10 is a container with wall parts 10A and a bottom part 10B. The bottom part 10B is a part that forms a bottom surface of the furnace body 10 on the Z2 direction side, and is formed so as to extend in the horizontal plane. The wall parts 10A are walls formed so as to protrude from an outer periphery of the bottom part 10B to the Z1 direction. An electrolytic solution E is stored in the furnace body 10, that is, in the space enclosed by the wall parts 10A and the bottom part 10B. The electrolytic solution E may have any composition with the electrically conductive property. For example, the electrolytic solution E may be a solution containing oxide, such as SiO₂, Al₂O₃, MgO, or CaO. At the time of smelting, the raw material A is dissolved in the electrolytic solution E and therefore, the electrolytic solution E contains the components of the dissolved raw material A, which is described below in detail.

The furnace bottom electrode 12 is provided on the Z2 direction side in the furnace body 10, more specifically at the bottom part 10B. The furnace bottom electrode 12 is a cathode in the electrolytic smelting furnace 100. As one example, the furnace bottom electrode 12 is a plate integrally formed of a metal material mainly containing tungsten. In the present embodiment, the furnace bottom electrode 12 is an integrally formed plate, but its shape may be an arbitrary shape.

The upper electrode 14 is provided on the Z1 direction side in the furnace body 10, more specifically on the Z1 direction side of the furnace bottom electrode 12 in the furnace body 10. In other words, the furnace bottom electrode 12 and the upper electrode 14 are provided facing each other in the furnace body 10. The upper electrode 14 is an anode in the electrolytic smelting furnace 100. The upper electrode 14 is formed of a member containing a conductive compound with a spinel-type structure. More specifically, in the present embodiment, the upper electrode 14 contains Fe₃O₄ (magnetite) as the conductive compound with the spinel-type structure. In the upper electrode 14, the conductive compound with the spinel-type structure, here Fe₃O₄, is preferably contained by 90% or more and 1005 or less in the total upper electrode 14. Although the upper electrode 14 contains Fe₃O₄ as the conductive compound with the spinel-type structure in the present embodiment, the content is not limited to this compound, and Mg and Al may alternatively be contained, for example. In this embodiment, the upper electrode 14 is a plate formed integrally but its shape may be an arbitrary shape, and for example, the upper electrode 14 may be composed of a plurality of cylindrical columnar members as described in a third embodiment below.

The collector 16 is provided in the bottom part 10B of the furnace body 10 and on the Z2 direction side of the furnace bottom electrode 12. The collector 16 is formed of a conductive material and is electrically connected to the furnace bottom electrode 12. Although two collectors 16 are provided in the example in FIG. 1, the number of collectors 16 is not limited to two. The housing 18 covers the furnace body 10, the furnace bottom electrode 12, the upper electrode 14, and the collector 16.

The loading unit 20 is a mechanism for loading the raw material A into the furnace body 10. For example, the loading unit 20 has an opening formed on the Z1 direction side of the furnace body 10, and loads the raw material A into the furnace body 10 through the opening. In the present embodiment, the loading unit 20 loads the raw material A into the furnace body 10 under the control of the control unit 26.

The power supply unit 22 is a power supply that can supply electric power. The power supply unit 22 is electrically connected to the upper electrode 14 and the collector 16. It can be said that the power supply unit 22 is electrically connected to the furnace bottom electrode 12 through the collector 16. The power supply unit 22 applies a positive voltage to the upper electrode 14 and a negative voltage to the collector 16, or in other words, to the furnace bottom electrode 12 through the collector 16. That is to say, the power supply unit 22 applies voltage between the upper electrode 14 and the furnace bottom electrode 12 to generate a potential difference between the upper electrode 14 and the furnace bottom electrode 12. In this embodiment, the power supply unit 22 applies voltage between the upper electrode 14 and the furnace bottom electrode 12 under the control of the control unit 26.

The heating unit 24 is a heating mechanism that heats the inside of the furnace body 10. The heating unit 24 heats the electrolytic solution E in the furnace body 10. Although the heating unit 24 is provided on the wall part 10A of the furnace body 10 in the example in FIG. 1, the position of the heating unit 24 may be arbitrarily set and the heating unit 24 may be provided to the upper electrode 14, for example, as described in the third embodiment below. The heating method by the heating unit 24 is also arbitrarily determined, and may be, for example, heating by electric heating or plasma. In this embodiment, the heating unit 24 heats the electrolytic solution E in the furnace body 10 under the control of the control unit 26.

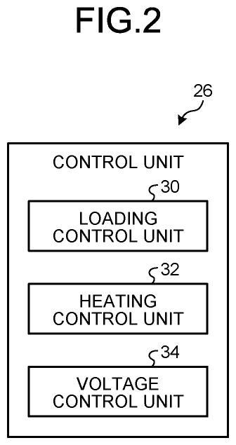

FIG. 2 is a schematic block diagram of the control unit in the first embodiment. The control unit 26 is a control device that controls each part of the electrolytic smelting furnace 100. The control unit 26 includes an arithmetic device, that is, a central processing unit (CPU). The control unit 26 executes the process described below by reading out and executing computer programs (software) from a storage unit (memory) not illustrated in the figure. As illustrated in FIG. 2, the control unit 26 may perform these functions with a single CPU, or may be equipped with multiple CPUs and perform these functions with those multiple CPUs. At least a part of each function may be realized by a hardware circuit.

The arithmetic device of the control unit 26 includes a loading control unit 30, a heating control unit 32, and a voltage control unit 34. The loading control unit 30 controls the loading unit 20. The loading control unit 30 causes the loading unit 20 to load the raw material A into the furnace body 10. The heating control unit 32 controls the heating unit 24. The heating control unit 32 causes the heating unit 24 to heat the electrolytic solution E in the furnace body 10. The voltage control unit 34 controls the power supply unit 22. The voltage control unit 34 causes the power supply unit 22 to apply voltage between the upper electrode 14 and the furnace bottom electrode 12. However, the loading unit 20, the power supply unit 22, and the heating unit 24 may be controlled by an operator instead of by the control unit 26.

Smelting by Electrolytic Smelting Furnace

Next, a method of smelting the object B using the electrolytic smelting furnace 100 with the above structure is described. The electrolytic smelting furnace 100 according to the first embodiment smelts FeV alloy or FeNb alloy as the object B. In other words, the electrolytic smelting furnace 100 can smelt at least one of the FeV alloy and FeNb alloy as the object B. However, the object B to be smelted by the electrolytic smelting furnace 100 is not limited to those listed above and may be any metal. For example, the electrolytic smelting furnace 100 may smelt at least one of V (vanadium), Nb (niobium), the FeV alloy, and the FeNb alloy. The FeV alloy is an alloy containing iron and vanadium, and the FeNb alloy is an alloy containing iron and niobium. It can also be said that the electrolytic smelting furnace 100 is preferable for smelting an alloy containing a first metal and a second metal. The first metal may be any metal, for example Fe, and the second metal may be any metal that is different from the first metal, for example V or Nb. It can also be said that the object B to be smelted by the electrolytic smelting furnace 100 preferably contains the metal contained in the conductive compound with the spinel-type structure of the upper electrode 14. That is, for example, if the upper electrode 14 is Fe₃O₄, the object B is preferably a metal that contains iron. By smelting the object B containing the metal contained in the upper electrode 14, mixing of a foreign material into the object B can be suppressed even when the upper electrode 14 is consumed and dissolved in the electrolytic solution E.

When the electrolytic smelting furnace 100 smelts the FeV alloy as the object B, it is preferable to smelt the object B so that the ratio of the V content to the entire alloy (the entire object B) becomes 30 wt % or more and 100 wt % or less. The FeV alloy to be smelted as the object B preferably contains no components other than Fe and V, except for unavoidable impurities. When the electrolytic smelting furnace 100 according to the first embodiment smelts the FeNb alloy as the object B, it is preferable to smelt the object B so that the ratio of the Nb content to the entire alloy (the entire object B) becomes 30 wt % or more and 100 wt % or less. The FeNb alloy to be smelted as the object B preferably contains no components other than Fe and Nb, except for unavoidable impurities.

When the object B is smelted using the electrolytic smelting furnace 100, the raw material A is loaded into the furnace body 10 from the loading unit 20 under the control of the loading control unit 30. As a result, the raw material A is added to the electrolytic solution E in the furnace body 10. The raw material A is oxide of the metal element contained in the object B. For example, in the case of smelting the FeV alloy as the object B, a raw material A1 containing iron oxide and a raw material A2 containing vanadium oxide are loaded as the raw material A. Iron oxide contained in the raw material A1 is, for example, Fe₂O₃ or Fe₃O₄. The raw material A1 containing iron oxide is, for example, iron ore, but may be any material containing iron oxide, such as iron scrap. Vanadium oxide contained in the raw material A2 is, for example, V₂O₅ or VO, and V₂O₅ is preferable. In the case of smelting the FeNb alloy as the object B, the raw material A1 containing iron oxide and a raw material A3 containing niobium oxide are loaded as the raw material A. Niobium oxide contained in the raw material A3 here is Nb₂O₅, NbO₂, Nb₂O, NbO, etc., and Nb₂O₅ is preferred.

When the electrolytic smelting furnace 100 according to the first embodiment is used to smelt the object B, the electrolytic solution E in the furnace body 10 is heated by the heating unit 24 under the control of the heating control unit 32. The heating unit 24 heats the electrolytic solution E to predetermined set temperature. The set temperature is based on the melting point of the raw material A to be added to the electrolytic solution E, or in other words, based on the type of the object B to be smelted. For example, in the case of smelting the FeV alloy as the object B, that is, adding the raw materials A1 and A2, the heating unit 24 heats the electrolytic solution E to 1200° C. or more and 1600° C. or less, more preferably 1400° C. or more and 1600° C. or less. When the set temperature is 1200° C. or more, vanadium oxide can be dissolved properly, and when the set temperature is 1600° C. or less, the dissolution of the upper electrode 14 can be properly suppressed. Additionally, by setting the temperature to 1400° C. or more, vanadium oxide can be dissolved more properly. For example, when the FeNb alloy is smelted as the object B, that is, the raw materials A1 and A3 are added, the heating unit 24 preferably heats the electrolytic solution E to 1200° C. or more and 1600° C. or less, and more preferably 1400° C. or more and 1600° C. or less. When the set temperature is 1200° C. or more, niobium oxide can be dissolved properly and when the set temperature is 1600° C. or less, the dissolution of the upper electrode 14 can be properly suppressed.

In this embodiment, after the raw material A is added to the electrolytic solution E, the electrolytic solution E is heated. That is to say, it can be said that the heating unit 24 heats the electrolytic solution E to which the raw material A is added, or heats the raw material A added to the electrolytic solution E. Thus, the raw material A is heated and dissolved in the electrolytic solution E. Alternatively, after the electrolytic solution E is heated to the set temperature, the raw material A may be loaded (that is to say, the electrolytic solution E without the raw material A is heated), and then the raw material A may be added to the electrolytic solution E. Even in this case, since the raw material A is added to the electrolytic solution E heated to the set temperature, the raw material A is heated by heat conduction and dissolved in the electrolytic solution E.

After the raw material A is dissolved in the electrolytic solution E as described above, the voltage control unit 34 controls to cause the power supply unit 22 to apply a positive voltage to the upper electrode 14 and a negative voltage to the furnace bottom electrode 12 through the collector 16. Thus, a potential difference is generated between the upper electrode 14 and the furnace bottom electrode 12, and an electrolytic reaction (reduction reaction) proceeds in the electrolytic solution E. Due to the electrolytic reaction (reduction reaction) in the electrolytic solution E, the metal contained in the raw material A dissolved in the electrolytic solution E precipitates as the object B and settles to the furnace bottom electrode 12 side (Z2 direction side) by its own weight. In other words, if the raw materials A1 and A2 are already dissolved, Fe in the raw material A1 and V in the raw material A2 will precipitate as the FeV alloy. If the raw materials A1 and A3 are already dissolved, Fe in the raw material A1 and Nb in the raw material A3 will precipitate as the FeNb alloy. As the precipitated object B settles more, the object B itself will function as the cathode in addition to the furnace bottom electrode 12. Note that oxygen is generated on the upper electrode 14 side.

In the electrolytic smelting furnace 100 according to the first embodiment, the object B is smelted in the aforementioned manner.

As described above, the electrolytic smelting furnace 100 according to the present embodiment includes the furnace body 10, the furnace bottom electrode 12 provided at the bottom part 10B in the furnace body 10, and the upper electrode 14 provided above the furnace bottom electrode 12 (Z1 direction side) in the furnace body 10. The upper electrode 14 contains the conductive compound with the spinel-type structure. Here, the electrolytic smelting furnace 100 smelts the object B by applying voltage between the furnace bottom electrode 12 and the upper electrode 14. In the electrolytic smelting furnace 100 with such a structure, the surface of the upper electrode 14 may be corroded because the electrolytic solution E and the raw material A of the object B may contain a component that corrodes the upper electrode 14. The corrosion of the upper electrode 14 fails the proper smelting of the object B. In contrast, the electrolytic smelting furnace 100 according to this embodiment uses the upper electrode 14 containing the conductive compound with the spinel-type structure, which makes it possible to use the upper electrode 14 as a consumable electrode that wears out according to the application of the voltage used. By using the upper electrode 14 as a consumable electrode, the corrosion of the surface can be suppressed and the object B can be smelted properly. In addition, since the electrolytic smelting furnace 100 according to this embodiment smelts the object B by electrolytic smelting, it is possible to reduce the generation of carbon dioxide.

The upper electrode 14 preferably contains Fe₃O₄. By using Fe₃O₄ as the upper electrode 14, the upper electrode 14 can work as a consumable electrode, the problems that occur when ordinary electrodes are used (such as film formation due to corrosion, loss of electrode functions such as insulation, etc.) can be avoided, and the object B can be smelted properly. In particular, when the FeV alloy or the FeNb alloy is smelted as the object B, Fe, which is the metal component of the upper electrode 14, will be contained in the object B. Therefore, even if the upper electrode 14 dissolves in the electrolytic solution E, mixing of foreign substances in the object B can be suppressed, and the object B can be smelted with high purity. Furthermore, when the FeV alloys is smelted, V acts as a corrosion component. In contrast, the electrolytic smelting furnace 100 according to this embodiment can suppress the loss of functions due to corrosion of the upper electrode 14 by using the upper electrode 14 containing Fe₃O₄, thereby properly smelting the FeV alloy. In this manner, by using the electrolytic smelting furnace 100 according to the present embodiment, the FeV alloy in particular can be smelted properly.

The content of Fe₃O₄ in the upper electrode 14 is preferably 90 wt % or more and 100 wt % or less. By setting the content of Fe₃O₄ in this range, the object B can be smelted properly.

The electrolytic smelting furnace 100 according to this embodiment preferably smelts at least one of V, Nb, the FeV alloy, and the FeNb alloy. Moreover, the electrolytic smelting furnace 100 preferably smelts at least one of the FeV alloy and FeNb alloy. The electrolytic smelting furnace 100 according to this embodiment can smelt these metals properly.

The electrolytic smelting method according to this embodiment performs electrolytic smelting by using the electrolytic smelting furnace 100. Therefore, by the electrolytic smelting method according to this embodiment, the object B can be smelted properly.

The composition of the object B may be adjusted after the object B is smelted in the electrolytic smelting furnace 100 and the object B is extracted from the electrolytic smelting furnace 100. In this case, the object B extracted from the electrolytic smelting furnace 100 is heated and melted and Fe, V, Nb, and other metals necessary for composition adjustment are added. Thus, the added metal can be contained in the object B to adjust the composition of the object B to the desired composition. For example, after the FeNb alloy containing Nb by 30 wt % or more and 100 wt % or less relative to Fe is smelted in the electrolytic smelting furnace 100, the FeNb alloy is melted and Fe is added; thus, the FeNb alloy containing Nb by 30 wt % or more and 100 wt % or less relative to Fe can be manufactured.

### Second Embodiment

Next, a second embodiment is described. The second embodiment is different from the first embodiment in that the value of the voltage to be applied between the upper electrode 14 and the furnace bottom electrode 12 is set based on the type of the object B to be smelted. The components of the second embodiment that have the structure common to those of the first embodiment are not described.

The electrolytic smelting furnace 100 smelts the object B by applying voltage between the upper electrode 14 and the furnace bottom electrode 12. In the second embodiment, the voltage control unit 34 sets the voltage value on the basis of the type of the object B to be smelted and applies voltage between the upper electrode 14 and the furnace bottom electrode 12 at the set voltage value, so that the object B can be smelted properly. Specific description is made below.

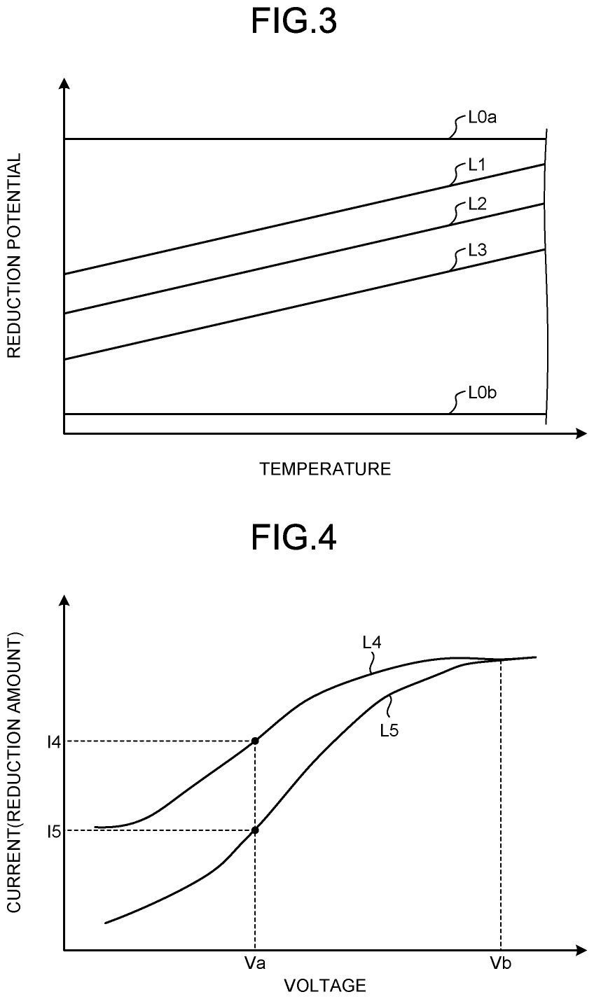

FIG. 3 is a graph expressing an example of the reduction potential at each temperature. In FIG. 3, a horizontal axis represents temperature and a vertical axis represents the reduction potential. In FIG. 3, a line L0a represents the potential of the upper electrode 14 and a line L0b represents the potential at which the reduction of the electrolytic solution E begins. When the potential of the upper electrode 14 is a potential V0a and the reduction potential of the electrolytic solution E is a potential V0b, the difference between the potential V0a and the potential V0b indicates the potential difference (voltage value) that can be applied, that is, the range where electrolysis is possible. A line L1 represents the reduction potential of Fe, a line L2 represents the reduction potential of V, and a line L3 represents the reduction potential of Nb. Hereinafter, assuming that the reduction potential of Fe is a potential V1, the reduction potential of Nb is a potential V2, and the reduction potential of V is a potential V3, the values of the reduction potentials decrease in the order of V1, V2, and V3. Accordingly, the potential difference (voltage) required for reduction increases in the order of Fe, Nb, and V. Each potential in FIG. 3 is an example.

When the FeV alloy is smelted, the voltage control unit 34 sets the voltage value to be applied between the upper electrode 14 and the furnace bottom electrode 12 to a value that is more than or equal to the difference between the potential V0a and the potential V3, and less than or equal to the difference between the potential V0a and the potential V0b. By applying voltage with the voltage value set to be more than or equal to the difference between the potential V0a and the potential V3, Fe and V can be properly reduced and the FeV alloy can be properly smelted. By setting the voltage value to a value less than or equal to the difference between the potential V0a and the potential V0b, electrolysis can be properly performed within the range where electrolysis is possible. When the FeNb alloy is smelted, the voltage control unit 34 sets the voltage value to be applied between the upper electrode 14 and the furnace bottom electrode 12 to a value that is more than or equal to the difference between the potential V0a and the potential V2, and less than or equal to the difference between the potential V0a and the potential V0b. By applying voltage with the voltage value set to be more than or equal to the difference between the potential V0a and the potential V2, Fe and Nb can be properly reduced and the FeNb alloy can be properly smelted. Thus, it can be said that the voltage control unit 34 sets the value of the voltage on the basis of the reduction potential at which the first metal and the second metal contained in the object B, which is an alloy, are reduced. It can also be said that the voltage control unit 34 sets the voltage value to be applied between the upper electrode 14 and the furnace bottom electrode 12 so that a potential difference higher than the reduction potential of the first metal and the second metal is generated between the upper electrode 14 and the furnace bottom electrode 12. When pure metals are smelted, the value of the voltage may be set based on the reduction potential of the pure metal. For example, in the case of smelting V, if the voltage value to be applied between the upper electrode 14 and the furnace bottom electrode 12 is more than or equal to the difference between the potential V0a and the potential V3, V can be properly reduced and smelted.

In the second embodiment, the voltage control unit 34 may set the voltage value to be applied between the upper electrode 14 and the furnace bottom electrode 12 so that the content ratio of the first metal (for example, Fe) and the second metal (for example, V) in the object B becomes a desired value. For example, the voltage control unit 34 may obtain in advance the relation between the voltage value applied between the upper electrode 14 and the furnace bottom electrode 12 and the smelting speed of the object B. Based on the relation, the voltage value may be set so that the content ratio of the first metal and the second metal in the object B becomes the desired value. The voltage control unit 34 may obtain in advance the relation between the voltage value applied between the upper electrode 14 and the furnace bottom electrode 12 and the wear speed (melting speed) of the upper electrode 14, and based on the relation, set the voltage value so that the content ratio between the first metal and the second metal in the object B becomes the desired value. The relation between the voltage value and the smelting speed of the object B and the relation between the voltage value and the wear speed of the upper electrode 14 are derived, for example, based on measurement values from experiments. By setting the voltage value on the basis of the smelting speed of the object B and the wear speed of the upper electrode 14, it is possible to properly maintain the composition of the object B even when the composition of the object B changes depending on the smelting speed and the wear speed.

FIG. 4 is a graph expressing one example of the current value flowing for each applied voltage when metal is reduced. In the second embodiment, the voltage control unit 34 may set the voltage value to be applied between the upper electrode 14 and the furnace bottom electrode 12 so that the content ratio between the first metal (for example, Fe) and the second metal (for example, V) in the object B becomes a desired value on the basis of the amount of metal reduced per unit time. In FIG. 4, a horizontal axis represents the voltage value applied between the anode and the cathode, and a vertical axis represents the current value flowing in the process. Here, the current value can also be said to be the amount of reduction per unit time, or the amount of metal precipitating per unit time. In FIG. 4, a line L4 represents an example of the relation between the voltage value and the current value when reducing Fe, and a line L5 represents an example of the relation between the voltage value and the current value when reducing V. As expressed in FIG. 4, in the range of relatively low voltage values, the current value flowing, or the amount of precipitation, differs for each metal even when the same voltage value is applied. On the other hand, when the voltage value is increased, that is, the voltage value becomes higher than or equal to Vb in the example in FIG. 4, the current value flowing when the same voltage value is applied, that is, the amount of precipitation is the same for each metal. Here, when the voltage value is set to Va, which is lower than Vb, the amount of Fe reduction (current value) is I4 and the amount of V reduction (current value) is I5. In this case, for example, when the FeV alloy is smelted by applying the voltage value Va, the ratio of the V content to the Fe content in the FeV alloy is I5/I4. On the other hand, when the voltage value is Vb or more, the ratio of the V content to the Fe content in the FeV alloy is 1, or 1:1.

A method for setting the voltage value on the basis of the amount of metal reduced per unit time is described more specifically. The desired value of the content ratio between the first metal and the second metal in the object B is the desired ratio. The voltage control unit 34 obtains the relation between the current value (the amount of metal reduced per unit time) and the voltage value regarding the first metal and the second metal as expressed in FIG. 4. Then, the voltage control unit 34 may obtain the voltage value at which the ratio between the amount of the first metal precipitated per unit time and the amount of the second metal precipitated per unit time becomes the desired ratio, and set that voltage value as the voltage value to be applied between the upper electrode 14 and the furnace bottom electrode 12. By setting the voltage value in this manner, the object B can be smelted with the desired ratio.

For example, the voltage control unit 34 may set the voltage value on the basis of the amount of the raw material A loaded into the furnace body 10. The voltage control unit 34 obtains the loading ratio, which is the ratio between the amount of the raw material A1 (here, iron oxide) loaded into the furnace body 10 from the loading unit 20 and the amount of the raw material A2 (here, vanadium oxide) loaded into the furnace body 10 from the loading unit 20. Based on the loading ratio, the voltage control unit 34 sets the voltage value so that the content ratio between the first metal and the second metal in the object B becomes the desired ratio. The content ratio between the first metal and the second metal in the object B varies also depending on the loading ratio. Therefore, by setting the voltage value on the basis of the loading ratio, the voltage control unit 34 can properly smelt the object B with the desired ratio. Although the voltage value is adjusted by the voltage control unit 34 in the above description, the voltage value may be fixed at a predetermined value and the loading ratio may be adjusted. In other words, the loading control unit 30 may set the loading ratio between the first raw material containing the first metal and the second raw material containing the second metal so that the content ratio between the first metal and the second metal in the object B becomes the desired ratio on the basis of the voltage value set by the voltage control unit 34. The loading control unit 30 then loads the first raw material and the second raw material into the furnace body 10 from the loading unit 20 at the set loading ratio. For example, when the voltage value is set to Vb expressed in FIG. 4, the ratio between the precipitation amount of the first metal and the amount of the second metal precipitating per unit time is equal, but if the content of the second metal in the object B is increased, the loading amount of the second raw material containing the second metal is increased. Thus, also by adjusting the loading ratio on the basis of the voltage value, the object B can be smelted properly at the desired ratio.

In the second embodiment, the structure of the electrolytic smelting furnace 100 is common to that in the first embodiment, but the structure of the electrolytic smelting furnace 100 may be different from that in the first embodiment. For example, in the second embodiment, the upper electrode 14 is not limited to being the member containing the conductive compound with the spinel-type structure and may be any member, such as a metal material containing iron, chromium, vanadium, or tantalum.

As described above, the electrolytic smelting furnace 100 according to the second embodiment includes the furnace body 10, the furnace bottom electrode 12 provided at the bottom part 10B in the furnace body 10, the upper electrode 14 provided above the furnace bottom electrode 12 in the furnace body 10, the power supply unit 22 that applies voltage between the furnace bottom electrode 12 and the upper electrode 14, and the voltage control unit 34 that controls the voltage applied by the power supply unit 22. The voltage control unit 34 sets the voltage value on the basis of the type of the object B to be smelted. In the electrolytic smelting furnace 100 according to the second embodiment, the object B can be smelted properly by setting the voltage value on the basis of the type of the object and applying the voltage between the upper electrode 14 and the furnace bottom electrode 12 with the set voltage value. In particular, in the case of smelting the alloy containing the first metal and the second metal as the object B, the content ratio, or the composition, of the first metal and the second metal in the object B can be adjusted properly by setting the voltage value on the basis of the type of the object.

The electrolytic smelting furnace 100 smelts the alloy containing the first metal and the second metal, and the voltage control unit 34 sets the voltage value on the basis of the reduction potential at which the first metal and the second metal are reduced. In the electrolytic smelting furnace 100 according to the second embodiment, the alloy can be smelted properly by setting the voltage value to be applied based on the reduction potential of the first metal and the second metal.

The voltage control unit 34 sets the voltage value so that the content ratio between the first metal and the second metal in the alloy (object B) becomes the desired value on the basis of the loading ratio between the first raw material containing the first metal and the second raw material containing the second metal to the electrolytic smelting furnace 100. In the electrolytic smelting furnace 100 according to the second embodiment, by setting the voltage value on the basis of the loading ratio, the object B can be smelted properly at the desired ratio.

The electrolytic smelting furnace 100 further includes the loading control unit 30 that loads the first raw material containing the first metal and the second raw material containing the second metal into the electrolytic smelting furnace 100. Based on the voltage value set by the voltage control unit 34, the loading control unit 30 sets the loading ratio between the first raw material and the second raw material to the electrolytic smelting furnace 100 so that the content ratio between the first metal and the second metal in the alloy (object B) becomes the desired value. In the electrolytic smelting furnace 100 according to the second embodiment, by setting the loading ratio on the basis of the voltage value, the object B can be smelted properly at the desired ratio.

### Third Embodiment

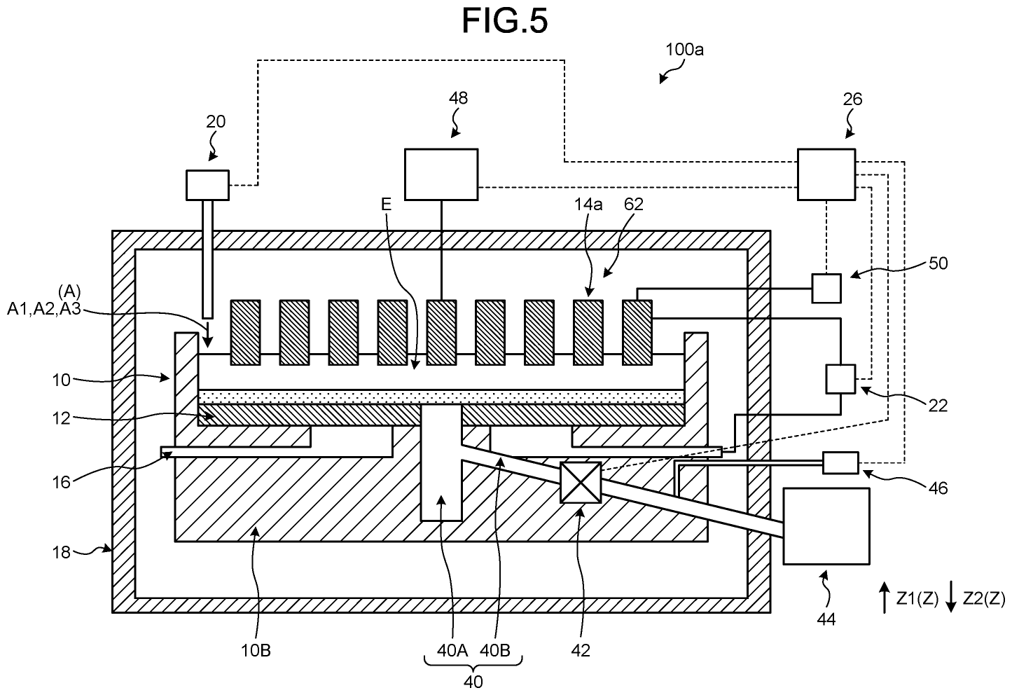

Next, a third embodiment is described. The third embodiment is different from the first embodiment in that a heating unit 62 illustrated in FIG. 5, which heats and melts the smelted object B, is provided. The components of the third embodiment that have the structure common to those of the first embodiment are not described.

Structure of electrolytic smelting furnace FIG. 5 is a schematic diagram of an electrolytic smelting furnace according to the third embodiment. As illustrated in FIG. 5, an electrolytic smelting furnace 100a according to the third embodiment includes the furnace body 10, the furnace bottom electrode 12, an upper electrode 14a, the collector 16, the housing 18, the loading unit 20, the power supply unit 22, the control unit 26, a discharge channel 40, a valve 42, a storage unit 44, a stirring unit 46, a moving mechanism 48, and a power supply unit 50. The upper electrode 14a includes the heating unit 62 that heats and melts the smelted object B.

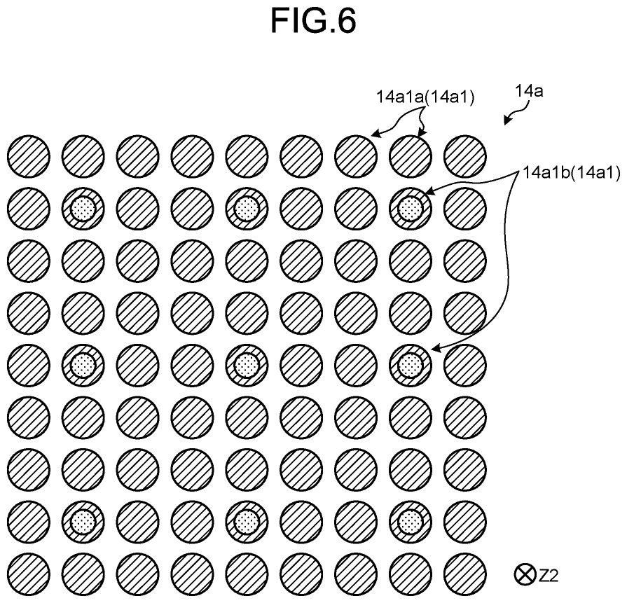

FIG. 6 is a schematic diagram of the upper electrode according to the third embodiment. In FIG. 6, the upper electrode 14a is viewed in the Z direction. The upper electrode 14a includes a plurality of electrodes 14a1. The electrode 14al is an anode of the electrolytic smelting furnace 100a. As illustrated in FIG. 6, the electrodes 14a1 are arranged in a lattice shape with equal spacing in the horizontal direction. Although the electrode 14al has a cylindrical columnar shape, the shape is not limited to the cylindrical columnar shape and may be an arbitrary shape.

The upper electrode 14a includes a first electrode 14a1a and a second electrode 14a1b as the electrodes 14a1. The first electrode 14a1a is the electrode 14al without the heating unit 62 described below, and the second electrode 14a1b is the electrode 14al with the heating unit 62 described below. The example in FIG. 6 illustrates the structure in which the second electrodes 14a1b are spaced horizontally from each other, that is, next to each other with the first electrodes 14a1a interposed therebetween. However, the arrangement and the number of the first electrodes 14a1a and the second electrodes 14a1b are not limited to this example, and can be changed as needed according to the design and specifications. The upper electrode 14a may exclude the first electrode 14a1a, and include only the second electrode 14a1b.

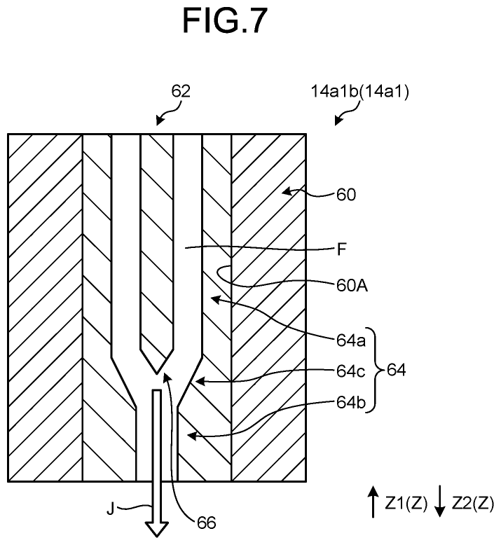

FIG. 7 is a schematic cross-sectional diagram of the second electrode in the third embodiment. As illustrated in FIG. 7, the second electrode 14a1b includes an anode part 60 and the heating unit 62. The anode part 60 is a part that constitutes the anode of the electrolytic smelting furnace 100a. The anode part 60 is formed of the same member as the upper electrode 14a in the first embodiment. However, the anode part 60 is not limited to being formed of the same member as the upper electrode 14a in the first embodiment and may be formed of any material, such as a metal material containing iron, chromium, vanadium, or tantalum. The anode part 60 is tubular and has a through-hole 60A formed penetrating in the Z direction.

The heating unit 62 is provided in the through-hole 60A of the anode part 60. The heating unit 62 includes a torch body 64 and a plasma torch electrode 66. The torch body 64 is a tubular member disposed on an inner peripheral surface of the through-hole 60A. The torch body 64 includes a large-diameter part 64a, a small-diameter part 64b, and a connection part 64c. The large-diameter part 64a is a part of the torch body 64 on the Z1 direction side, and the small-diameter part 64b is a part of the torch body 64 on the Z2 direction side. The connection part 64c is a part between the large-diameter part 64a and the small-diameter part 64b, and can be regarded as the part that connects between the large-diameter part 64a and the small-diameter part 64b. The inner diameter of the large-diameter part 64a is larger than the inner diameter of the small-diameter part 64b. The inner diameter of the connection part 64c gradually decreases to the Z2 direction.

The plasma torch electrode 66 is an electrode placed inside the torch body 64. More specifically, the plasma torch electrode 66 is disposed on the inner peripheral side of the large-diameter part 64a. The plasma torch electrode 66 is a rod-shaped electrode whose outer diameter is smaller than the inner diameter dimension of the large-diameter part 64a. Between the outer peripheral surface of the plasma torch electrode 66 and the inner peripheral surface of the large-diameter part 64a, a gap is formed as a flow channel F. In the flow channel F, working gas supplied from outside flows from the Z1 direction side to the Z2 direction side. The working gas is inert gas such as Ar or N2, and may alternatively be any gas, for example, flammable gas such as hydrogen. With the working gas flowing in the flow channel F, voltage is applied by the power supply unit 50 between the torch body 64 and the plasma torch electrode 66. The working gas flowing through the flow channel F is ionized by electric conduction between the torch body 64 and the plasma torch electrode 66 with the voltage from the power supply unit 50; thus, a plasma jet J with high temperature is formed. The plasma jet J is spouted from an end part of the heating unit 62 on the Z2 direction side toward the furnace bottom electrode 12.

The second electrode 14a1b is configured as described above. The first electrode 14a1a includes the anode part 60, which is described below, and does not include the heating unit 62.

Back to FIG. 5, the discharge channel 40 is formed at the bottom part 10B of the furnace body 10 and is the channel through which the object B melted by the heating unit 62 is discharged. The discharge channel 40 includes a first discharge channel 40A and a second discharge channel 40B. The first discharge channel 40A is a flow channel that extends at the bottom part 10B of the furnace body 10 in the Z direction, with its end part on the Z1 direction side communicating with the inside of the furnace body 10. The second discharge channel 40B is a flow channel that extends in the Z2 direction, with its end part on the Z1 direction side connected to the first discharge channel 40A. The second discharge channel 40B has an end part on the Z2 direction side connected to the storage unit 44. The storage unit 44 is a tank in which the object B discharged from the furnace body 10 is stored. The shape of the discharge channel 40 is not limited to the shape illustrated in FIG. 5.

The valve 42 is a valve in the discharge channel 40, more specifically in the second discharge channel 40B. The valve 42, when closed, covers the second discharge channel 40B, thereby preventing the melted object B from being discharged from the furnace body 10 through the first discharge channel 40A and the second discharge channel 40B to the storage unit 44. The valve 42, when opened, uncovers the second discharge channel 40B to allow the melted object B to be discharged from the furnace body 10 through the first discharge channel 40A and the second discharge channel 40B to the storage unit 44. The valve 42 is controlled to be opened and closed by the control unit 26.

The stirring unit 46 is provided in the discharge channel 40, more specifically in the second discharge channel 40B. The stirring unit 46 stirs the melted object B that is discharged from the discharge channel 40. Specifically, the stirring unit 46 supplies (spouts) gas in the second discharge channel 40B so as to supply the gas to the melted object B in the second discharge channel 40B. The stirring unit 46 supplies gas to the melted object B so as to stir the melted object B in the second discharge channel 40B. The stirring unit 46 supplies the gas under the control of the control unit 26. The gas discharged by the stirring unit 46 is inert gas, such as N2 or Ar. The gas discharged by the stirring unit 46 may be a rare gas other than Ar. The stirring unit 46 is not limited to being installed in the second discharge channel 40B and may alternatively be installed in the first discharge channel 40A or the storage unit 44, for example. The electrolytic smelting furnace 100a may include a gas supply unit that supplies gas, which is similar to the gas from the stirring unit 46, to the electrolytic solution E in the furnace body 10.

The moving mechanism 48 is a mechanism that moves the upper electrode 14a. The moving mechanism 48 moves the upper electrode 14a in the Z direction. The moving mechanism 48 moves the upper electrode 14a under the control of the control unit 26.

Smelting by Electrolytic Smelting Furnace

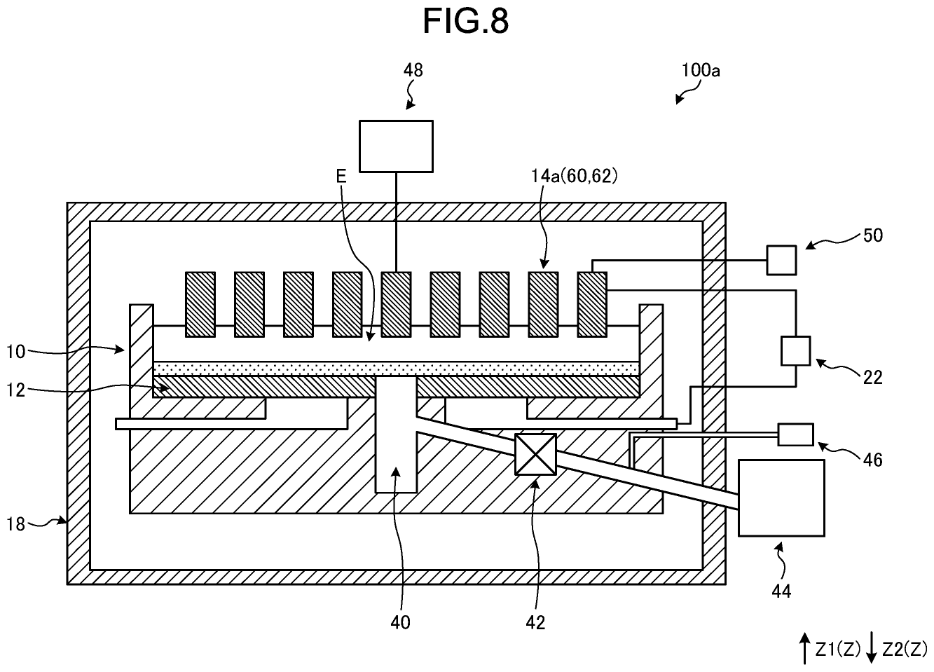

Next, smelting using the electrolytic smelting furnace 100a according to the third embodiment is described. FIG. 8 is a schematic diagram illustrating the position of the upper electrode at the smelting. As illustrated in FIG. 8, when the object B is smelted, the moving mechanism 48 puts the upper electrode 14a at a first position under the control of the control unit 26. The first position is a position where at least a part of the upper electrode 14a is immersed in the electrolytic solution E in the furnace body 10, and where the end part of the upper electrode 14a on the Z2 direction side is more on the Z2 direction side than the liquid level of the electrolytic solution E in the furnace body 10. In the example in FIG. 8, at the first position, only the end part of the upper electrode 14a on the Z2 direction side is immersed in the electrolytic solution E. However, the structure is not limited to this example, and the entire upper electrode 14a may be immersed in the electrolytic solution E.

When the object B is smelted, the raw material A is loaded into the furnace body 10 from the loading unit 20 under the control of the control unit 26 in a manner similar to the first embodiment. In the third embodiment, the electrolytic solution E in the furnace body 10 is heated by the heating unit 62 with the upper electrode 14a placed at the first position under the control of the control unit 26. Since the heating unit 62 is provided to the upper electrode 14a (second electrode 14a1b), the heating unit 62 is immersed in the electrolytic solution E when the object B is smelted. In other words, the heating unit 62 heats the electrolytic solution E to the set temperature while immersed in the electrolytic solution E. However, the position of the upper electrode 14a at the smelting of the object B is not limited to the first position, and may be an arbitrary position. For example, when the object B is smelted, the moving mechanism 48 may place the upper electrode 14a at a second position for heating the object B, as described below, or may place the upper electrode 14a at, instead of the same second position as when heating the object B, any position where the upper electrode 14a is not immersed in the electrolytic solution E.

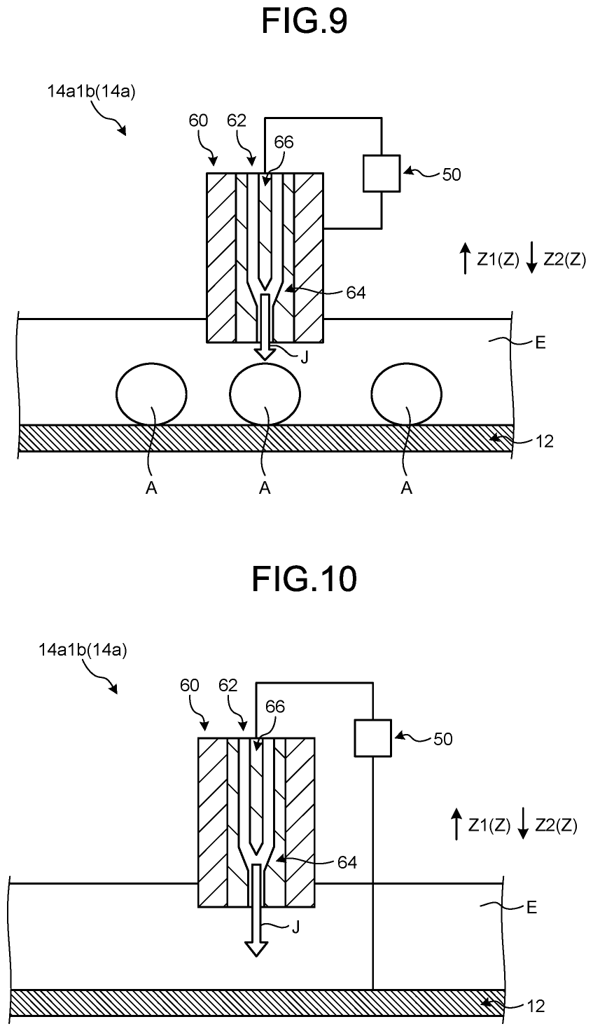

FIG. 9 and FIG. 10 are schematic diagrams for describing the heating of the electrolytic solution in the third embodiment. In the third embodiment, as illustrated in FIG. 9, the heating unit 62 first heats the electrolytic solution E in a state where the raw material A added to the electrolytic solution E has not melted. Specifically, as illustrated in FIG. 9, the control unit 26 applies voltage between the torch body 64 and the plasma torch electrode 66 by the power supply unit 50. This voltage causes the heating unit 62 to form the plasma jet J. The formed plasma jet J is then supplied into the electrolytic solution E. The plasma jet J supplied into the electrolytic solution E heats the electrolytic solution E and the raw material A, and dissolves the raw material A.

When the raw material A starts to melt, the operation of the heating unit 62 is changed. Specifically, as illustrated in FIG. 10, the power supply unit 50 feeds electricity between the plasma torch electrode 66 and the furnace bottom electrode 12 and applies voltage between the plasma torch electrode 66 and the furnace bottom electrode 12. This voltage causes the heating unit 62 to form the plasma jet J between the heating unit 62 and the furnace bottom electrode 12. The plasma jet J dissolves the entire raw material A, which had begun to dissolve.

After the raw material A is melted as described above, the object B is smelted by applying voltage between the upper electrode 14 and the furnace bottom electrode 12 in the manner similar to the first embodiment.

Here, while the object B is smelted, that is, during electrolysis, the electrolytic solution E is kept at high temperature near the set temperature due to the Joule heat at the electrolysis. Therefore, the object B to be smelted may be able to maintain its melted liquid state, and the object B can be continuously extracted while electrolysis is performed. However, when the object B whose melting point is higher than the temperature at the electrolysis is smelted, the object B will precipitate as a solid, and extraction of the object B may become difficult. In contrast, in the third embodiment, after the object B is smelted, the heating unit 62 heats the object B to a higher temperature than the temperature at the time of electrolysis, or in other words, to a higher temperature than the set temperature at the time of smelting, so that the object B is melted and the object B is extracted from the furnace body 10. The process of heating the object B is described below.

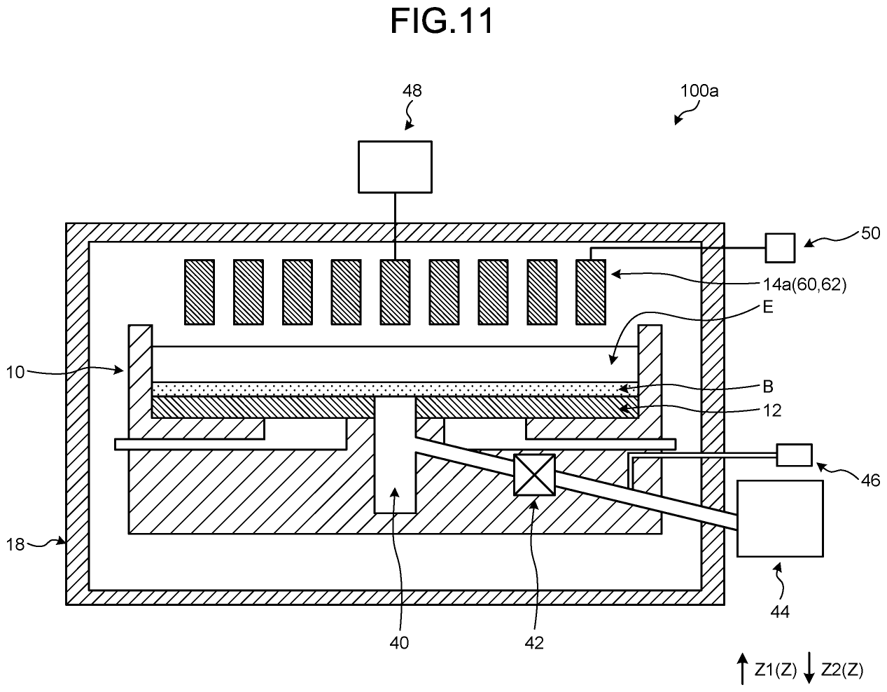

FIG. 11 is a schematic diagram illustrating the position of the upper electrode at the heating of the object. As illustrated in FIG. 11, when the smelted object B is heated, the moving mechanism 48 puts the upper electrode 14a at the second position under the control of the control unit 26. The second position is a position where the upper electrode 14a is not immersed in the electrolytic solution E in the furnace body 10, and where the end part of the upper electrode 14a on the Z2 direction side is more on the Z1 direction side than the liquid level of the electrolytic solution E in the furnace body 10. The second position can be regarded as the position more on the Z1 direction side than the first position. In other words, after the smelting of the object B stops, the moving mechanism 48 moves the upper electrode 14a to the Z1 direction so as to move the upper electrode 14a from the first position to the second position.

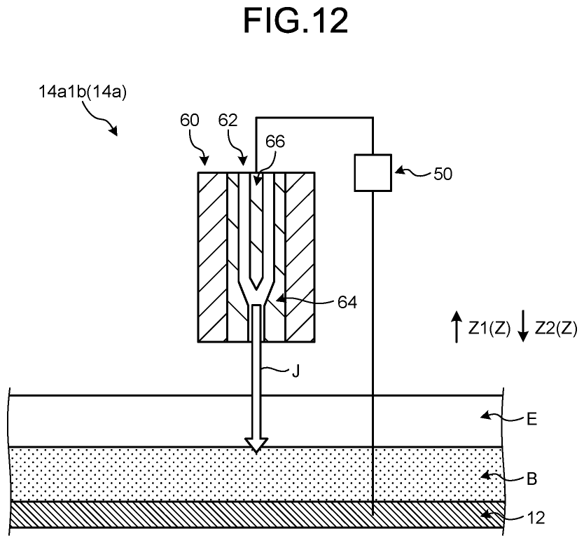

FIG. 12 is a schematic diagram for describing the heating of the object in the third embodiment. As illustrated in FIG. 12, the heating unit 62 heats the object B in the furnace body 10 with the upper electrode 14a placed at the second position under the control of the control unit 26. Since the heating unit 62 is provided to the upper electrode 14a, the heating unit 62 heats the object B in the furnace body 10 from a position where the heating unit 62 itself is not immersed in the electrolytic solution E. The heating unit 62 heats the object B to a temperature higher than the set temperature (heating temperature at smelting), or more specifically, to a temperature higher than or equal to the melting point of the object B. Specifically, if the object B is the FeV alloy, the heating unit 62 preferably heats the object B to 1200° C. or more and 1600° C. or less. If the object B is the FeNb alloy, the heating unit 62 preferably heats the object B to 1200° C. or more and 1600° C. or less.

Specifically, as illustrated in FIG. 12, the power supply unit 50 feeds electricity between the plasma torch electrode 66 and the furnace bottom electrode 12 and applies voltage between the plasma torch electrode 66 and the furnace bottom electrode 12. This voltage causes the heating unit 62 to form the plasma jet J between the heating unit 62 and the furnace bottom electrode 12. The plasma jet J is delivered into the electrolytic solution E to heat and melt the object B formed on the furnace bottom electrode 12 in the electrolytic solution E. Here, when the object B is heated, the upper electrode 14a is not immersed in the electrolytic solution E. Therefore, the upper electrode 14a is not heated and the melting is suppressed.

When the object B is heated, the control unit 26 opens the valve 42 and causes the stirring unit 46 to supply the gas. As a result, the heated and melted object B, while being stirred by the gas from the stirring unit 46, is discharged from the furnace body 10 into the storage unit 44 through the first discharge channel 40A and the second discharge channel 40B. When the discharge of the object B is completed, the control unit 26 closes the valve 42 and stops the gas supply from the stirring unit 46.

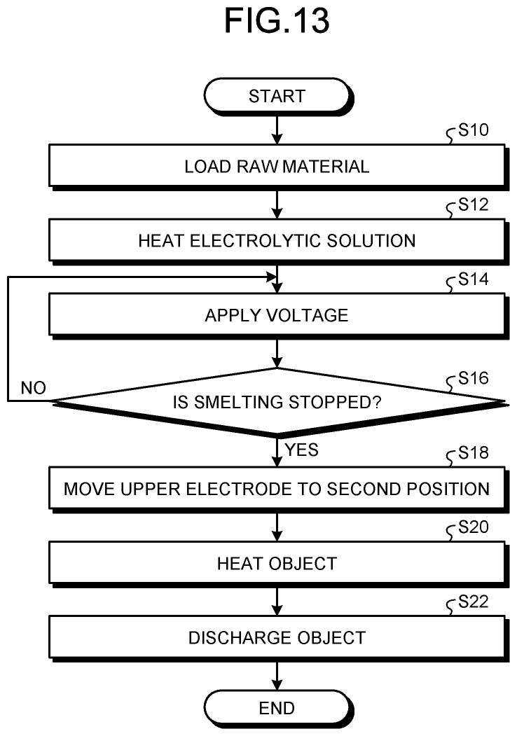

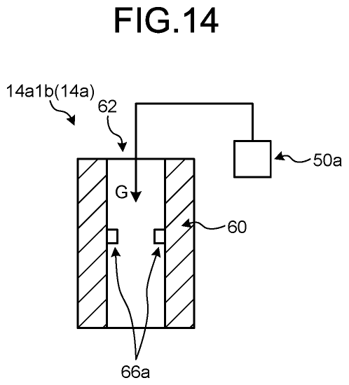

The process flow of the aforementioned smelting and melting of the object B is described with reference to a flowchart. FIG. 13 is a flowchart for describing the process of the smelting and melting of the object in the third embodiment. As illustrated in FIG. 13, when the object B is smelted, first, the raw material A is loaded into the furnace body 10 from the loading unit 20 (step S10). Then, with the upper electrode 14a placed at the first position by the moving mechanism 48, the heating unit 62 heats the electrolytic solution E in the furnace body 10 to the set temperature (step S12). Heating the electrolytic solution E dissolves the raw material A added to the electrolytic solution E. The raw material A may be loaded after the electrolytic solution E is heated by the heating unit 62 also in the third embodiment. After the electrolytic solution E is heated to dissolve the raw material A, the voltage is applied between the upper electrode 14 and the furnace bottom electrode 12 by the power supply unit 22 (step S14) to smelt the object B. Then, whether to stop smelting of the object B is determined (step S16). If smelting is not stopped (No at step S16), the process returns to step S14 and smelting is continued. Whether to stop smelting may be determined arbitrarily. For example, the current value flowing in the electrolytic solution E (the current value flowing in the circuit of the upper electrode 14, the furnace bottom electrode 12, and the power supply unit 22) when the voltage is applied between the upper electrode 14 and the furnace bottom electrode 12 is detected in advance, and based on the current value, whether to stop the smelting may be determined. For example, if the current value is higher than or equal to a predetermined value, it may be determined that smelting will continue, assuming that enough ions of the metal contained in the raw material A remain in the electrolytic solution E. If the current value becomes less than the predetermined value, it may be determined that smelting is to be stopped, assuming that the amount of ions of the metal contained in the raw material A has decreased. As mentioned above, the position of the upper electrode 14a at smelting of the object B is not limited to the first position, and may be an arbitrary position.

If smelting is to be stopped (Yes at step S16), the process advances to the melting process of the object B and the moving mechanism 48 moves the upper electrode 14a from the first position to the second position (step S18). More specifically, in the case of stopping the smelting, the application of voltage by the power supply unit 22 is stopped and the upper electrode 14a is moved from the first position to the second position. Then, with the upper electrode 14a placed at the second position, the heating unit 62 heats and melts the object B in the furnace body 10 (step S20). Then, for example, by opening the valve 42, the melted object B is discharged from the furnace body 10 to the outside (step S22).

As described above, the electrolytic smelting furnace 100a according to the third embodiment includes the furnace body 10 in which the electrolytic solution E is stored, the furnace bottom electrode 12 provided at the bottom part 10B in the furnace body 10, the upper electrode 14a provided on the Z1 direction side of (above) the furnace bottom electrode 12 in the furnace body 10, the heating unit 62 provided to the upper electrode 14 to heat and melt the smelted object B, and the moving mechanism 48 to move the upper electrode 14a. The moving mechanism 48 places the upper electrode 14a at the second position where the upper electrode 14a is not immersed in the electrolytic solution E when the smelted object B is heated by the heating unit 62. In the electrolytic smelting furnace 100a according to the third embodiment, by heating the smelted object B with the heating unit 62, the object B can be melted and properly discharged outside the furnace body 10, even if the smelted object B precipitates as a solid. In order to melt the object B, it is necessary to heat the object B at a higher temperature than at the smelting. However, if the heat used to heat the object B conducts to the upper electrode 14a, there is a risk that the upper electrode 14a will melt. In contrast, in the electrolytic smelting furnace 100a according to the third embodiment, the upper electrode 14a is moved to the position where the upper electrode 14a is not immersed in the electrolytic solution E when the object B is heated. Thus, the conduction of the heat used to heat the object B to the upper electrode 14a can be suppressed and accordingly, the melting of the upper electrode 14a can be suppressed. Therefore, in the electrolytic smelting furnace 100a according to the third embodiment, the object B can be smelted properly. In the electrolytic smelting furnace 100a according to the third embodiment, since the object B is melted, the object B can be homogenized and pores of the porous object can be removed, thereby suppressing the mixing of oxygen.

The heating unit 62 is provided to the upper electrode 14a. In the electrolytic smelting furnace 100a according to the third embodiment, the smelting and melting of the object B can be properly performed by providing the heating unit 62 to the upper electrode 14a. However, the heating unit 62 is not limited to being provided to the upper electrode 14a, and may be provided separate from the upper electrode 14a. The position of the heating unit 62 in this case is an arbitrary position. For example, the heating unit 62 may exist at the position similar to the position of the heating unit 24 in the first embodiment, or may exist adjacent to the upper electrode 14a. Even if the heating unit 62 is made separate from the upper electrode 14a, the melting of the upper electrode 14a can be suppressed because the upper electrode 14a is moved to the position where the upper electrode 14a is not immersed in the electrolytic solution E when the object B is heated.

The heating unit 62 includes the tubular torch body 64 that is provided on the inner peripheral side of the through-hole 60A formed in the upper electrode 14a, and the plasma torch electrode 66 that is provided on the inner peripheral side of the torch body 64. In the electrolytic smelting furnace 100a according to the third embodiment, the object B can be properly heated by using the plasma method for the heating unit 62. However, the heating unit 62 may employ any heating method and structure that can heat the object B. FIG. 14 is a schematic diagram illustrating another example of the heating unit according to the third embodiment. For example, as illustrated in FIG. 14, the heating unit 62 may include a gas supply unit 50a and an ignition unit 66a. The gas supply unit 50a supplies flammable gas G, such as a gas containing hydrogen, to the ignition unit 66a. The ignition unit 66a is provided on the inner peripheral side of the anode part 60. The ignition unit 66a ignites the gas G supplied from the gas supply unit 50a. Thus, the heating unit 62 generates a flame, and the flame can heat the object B. The flame may also be used to heat the electrolyte solution E during the smelting of the object B.

The electrolytic smelting furnace 100a according to the third embodiment further includes the discharge channel 40 formed at the bottom part 10B of the furnace body 10, through which the object B melted by the heating unit 62 is discharged, and the stirring unit 46 that stirs the melted object B discharged from the discharge channel 40. In this electrolytic smelting furnace 100a, the melted object B can be homogenized by stirring.

The stirring unit 46 supplies the inert gas to the melted object B. In this electrolytic smelting furnace 100a, the melted object B can be homogenized while suppressing the modification of the object B by stirring with the inert gas.

The embodiments of the present invention have been described above, but the embodiments are not limited by the contents herein. In addition, the aforementioned components include those that can be easily conceived by persons skilled in the art, those that are substantially identical, and those that are within a so-called equivalent range. Furthermore, the aforementioned components can be combined as appropriate, and the embodiments can be combined with each other. Furthermore, various omissions, substitutions, or changes of the components can be made in the range without departing from the contents of the aforementioned embodiments.

### REFERENCE SIGNS LIST

10 Furnace body
10A Wall part
10B Bottom part
12 Furnace bottom electrode
14, 14a Upper electrode
16 Collector
18 Housing
20 Loading unit
22 Power supply unit
24, 62 Heating unit
26 Control unit
48 Moving mechanism
100 Electrolytic smelting furnace
A Raw material
B Object
E Electrolytic solution

1. An electrolytic smelting furnace comprising:
a furnace body;
a furnace bottom electrode provided at a bottom part in the furnace body; and
an upper electrode provided above the furnace bottom electrode in the furnace body, the upper electrode including a conductive compound with a spinel-type structure.

2. The electrolytic smelting furnace according to claim 1, wherein the upper electrode contains Fe₃O₄.

3. The electrolytic smelting furnace according to claim 1, wherein the upper electrode contains Fe₃O₄ by 90 wt % or more and 100 wt % or less.

4. The electrolytic smelting furnace according to claim 1, further comprising:
a power supply unit that applies voltage between the furnace bottom electrode and the upper electrode; and
a voltage control unit that controls the voltage applied by the power supply unit, wherein
the voltage control unit sets a value of the voltage, based on a type of an object to be smelted.

5. An electrolytic smelting furnace comprising:
a furnace body;
a furnace bottom electrode provided at a bottom part in the furnace body;
an upper electrode provided above the furnace bottom electrode in the furnace body;
a power supply unit that applies voltage between the furnace bottom electrode and the upper electrode; and
a voltage control unit that controls the voltage applied by the power supply unit, the voltage control unit setting a value of the voltage based on a type of an object to be smelted.

6. The electrolytic smelting furnace according to claim 5, wherein
the electrolytic smelting furnace smelts an alloy containing a first metal and a second metal, and
the voltage control unit sets the value of the voltage based on a reduction potential at which the first metal and the second metal are reduced.

7. The electrolytic smelting furnace according to claim 6, wherein the voltage control unit sets the value of the voltage so that a content ratio between the first metal and the second metal in the alloy becomes a desired value, based on a loading ratio between a first raw material containing the first metal and a second raw material containing the second metal to the electrolytic smelting furnace.

8. The electrolytic smelting furnace according to claim 6, further comprising a loading control unit that loads a first raw material containing the first metal and a second raw material containing the second metal to the electrolytic smelting furnace, wherein
the loading control unit sets a loading ratio between the first raw material and the second raw material to the electrolytic smelting furnace so that a content ratio between the first metal and the second metal in the alloy becomes a desired value, based on the value of the voltage set by the voltage control unit.

9. The electrolytic smelting furnace according to claim 1, further comprising:
a heating unit that heats and melts the object that is smelted; and
a moving mechanism that moves the upper electrode, wherein
an electrolytic solution is stored in the furnace body, and
when the smelted object is heated by the heating unit, the moving mechanism places the upper electrode at a position where the upper electrode is not immersed in the electrolytic solution.

10. An electrolytic smelting furnace comprising:
a furnace body in which an electrolytic solution is stored;
a furnace bottom electrode provided at a bottom part in the furnace body;
an upper electrode provided above the furnace bottom electrode in the furnace body;
a heating unit that heats and melts a smelted object; and
a moving mechanism that moves the upper electrode, wherein when the smelted object is heated by the heating unit, the moving mechanism places the upper electrode at a position where the upper electrode is not immersed in the electrolytic solution.

11. The electrolytic smelting furnace according to claim 10, wherein the heating unit is provided to the upper electrode.

12. The electrolytic smelting furnace according to claim 11, wherein the heating unit includes a torch body with a tubular shape provided on an inner peripheral side of a through-hole formed in the upper electrode, and a plasma torch electrode provided on an inner peripheral side of the torch body.

13. The electrolytic smelting furnace according to claim 10, further comprising a discharge channel formed at a bottom part of the furnace body and discharging the object melted by the heating unit, and a stirring unit that stirs the melted objected that is discharged from the discharge channel.

14. (canceled)

15. The electrolytic smelting furnace according to claim 1, wherein at least one of V, Nb, FeV alloy, and FeNb alloy is smelted.

16. (canceled)

17. An electrolytic smelting method for performing electrolytic smelting with the electrolytic smelting furnace according to claim 1.

18. The electrolytic smelting furnace according to claim 5, further comprising:
a heating unit that heats and melts the object that is smelted; and
a moving mechanism that moves the upper electrode, wherein
an electrolytic solution is stored in the furnace body, and
when the smelted object is heated by the heating unit, the moving mechanism places the upper electrode at a position where the upper electrode is not immersed in the electrolytic solution.

19. The electrolytic smelting furnace according to claim 5, wherein at least one of V, Nb, FeV alloy, and FeNb alloy is smelted.

20. An electrolytic smelting method for performing electrolytic smelting with the electrolytic smelting furnace according to claim 5.

21. The electrolytic smelting furnace according to claim 10, wherein at least one of V, Nb, FeV alloy, and FeNb alloy is smelted.

22. An electrolytic smelting method for performing electrolytic smelting with the electrolytic smelting furnace according to claim 10.
